(19) United States
(12) Patent Application Publication
(10) Pub. No.: US 2006/0248504 A1
(43) Pub. Date: Nov. 2, 2006

(54) Systems and methods for software development

(76) Inventor: John M. Hughes, Hebron, CT (US)

Correspondence Address: GOODWIN PROCTER LLP;PATENT ADMINISTRATOR, EXCHANGE PLACE, BOSTON, MA, 02109-2881, US

(21) Appl. No.: 11/375,376

(22) Filed: Mar. 14, 2006

Related U.S. Application Data
(63) Continuation-in-part of application No. 11/035,783, filed on Jan. 14, 2005.
(63) Continuation-in-part of application No. 10/408,402, filed on Apr. 7, 2003.
(60) Provisional application No. 60/536,760, filed on Jan. 15, 2004.
(60) Provisional application No. 60/370,937, filed on Apr. 8, 2002.

(51) Int. Cl. G06F 9/44

(52) U.S. Cl. 717/101

(57) ABSTRACT

This invention relates to methods and a system for developing software applications using software components. In one embodiment, a method for developing an application includes facilitating online software programming contests, some of which result in the development of software components. A specification describing the software components to be used in the development of the application and the design of the software application is provided to developers and, in response to the communicated specification, assembled applications comprised of one or more of the software components are received. A review process for scoring each of the received applications is facilitated, and based on the review process, one of the received applications application is selected.

### CROSS-REFERENCE TO RELATED APPLICATIONS

This application claims priority to and is a continuation in part of U.S. patent application Ser. Nos. 10/408,402, filed Apr. 7, 2003, and 11/035,783, filed Jan. 14, 2005, both of which claim priority to U.S. provisional patent application Ser. No. 60/370,937, filed Apr. 8, 2002 and U.S. provisional patent application Ser. No. 60/536,760, filed Jan. 15, 2004.

### TECHNICAL FIELD

This invention relates to computer-based methods and systems for developing and distributing software and, more particularly, to methods and systems facilitating the distributed development of software.

### BACKGROUND INFORMATION

In the United States and elsewhere, computers have become part of people's everyday lives, both in the workplace and in personal endeavors. This is because a general-purpose computer can be programmed to run a variety of software programs each providing different processing and networking functions. Computer programmers develop computer code. Some companies hire large numbers of computer programmers to develop code on the company's behalf.

One approach is to hire large numbers of programmers and develop software “in house.” While this affords significant control over the programming staff, finding, hiring, and maintaining such a staff can be cost prohibitive. Furthermore, as individual programmers leave the company, much of the technical and industrial knowledge is also lost. Alternatively, many companies “outsource” their programming through consulting firms, or contract employees. This approach relieves the company of the burdens of managing individual employees, however the quality and consistency of the work may be suspect, and the challenges of integrating work from numerous outside vendors can be significant.

### SUMMARY OF THE INVENTION

Organizations need to obtain high-quality software while being assured that the code is developed using appropriate quality measures. Techniques that have been suggested to improve software development are code re-use and component-based design. But even if organizations adopt such techniques, they still need to obtain high-quality components in an affordable manner.

In general, the invention relates to providing infrastructure, process controls, and manpower to develop software using a repeatable, structured model in order to transform software development from an ad-hoc, custom development exercise into a streamlined, predictable manufacturing operation. Generally speaking, this goal can be achieved, in one exemplary implementation, by separating the software design functions from the software development functions, providing rigorous review processes, and using a competition model whereby a number of distributed, unrelated, and motivated developers submit multiple software designs or programs, from which the eventual software design or program is selected.

Furthermore, software development firms can be employed to perform only a portion of an entire process. For example, a consulting firm may be hired to develop a functional specification for an application addressing a certain business need, or an offshore programming shop engaged to build software according to the specification. A multi-step software development manufacturing process that has well-defined inputs and outputs at each step, meets stringent quality control requirements, and catalogs each process output as a subassembly component of the larger product, allows such flexibility without sacrificing quality. Such a process can be entered (or exited) at various points, while the independence of the developers allows for enforcement of rigorous design and quality analysis without “office politics” or other favoritism, which in turn results in very high quality (e.g., enterprise quality) software.

In one aspect, online software programming contests are facilitated such that completed software components result from some of the contests. A specification for the design of an application is sent to a plurality of developers, the specification describing the components to be used in the development of the application. In response, assembled applications comprised of one or more of the software components are received from a subset of the plurality of developers. A review process for review of the received applications is facilitated, and based at least in part on the results, one application is selected.

Various embodiments can include one or more of the following features. Developers' skill ratings can be derived from the developer's performances in one or more coding competitions, which (in whole or in part) can be held online. For example, the first plurality of software developers can be selected based, at least in part, on having achieved a minimum rating received in the one or more competitions. The ratings assigned to a developer can be derived (in whole or in part) from the score associated with one or more designs or programs. A difficulty level can be associated with the software program, and in some embodiments, the developers can be rated based, at least in part, on the difficulty level associated with the design or program.

Prior to communicating the specification, a portion of the specification can be received from an entity requesting the development of an application. In some cases, the specification can be communicated using an on-line application, using, for example, the Internet. The method can further include rewarding the software developer that submitted the selected application or program with, for example, monetary rewards and/or increased skill ratings.

The review process may be performed by a plurality of reviewers, who in some cases may have been previously rated in a computer programming competition, and may have achieved a rating above a predetermined minimum rating. Where a plurality of reviewers participate in the review, the review process can include aggregating scores from each of the plurality of reviewers into a summary rating, and the selection of one application can be based on the summary score. The design review process can include one or more activities such as reading documents, completing a review form, which in some cases my be an on-line form, and identifying changes to be incorporated into the application by the software developer who submitted the application. The changes can be designated as mandatory or optional at the discretion of the reviewer. In some embodiments, an appeal can be made contesting the score assigned to a software developer's application. A selected application can be distributed, and in some cases support for the distributed application may be provided.

In yet another aspect, the invention relates to systems for implementing the methods just described. For example, a system for evaluating the functionality of software programs includes a contest server for facilitating a plurality of online software programming contests, some of which result in one or more software components, a communications server for communicating a specification for the design of a software application to a plurality of developers, the specification describing a plurality of the software components to be used in the development of the application; and a scoring server in communication with the communication server for scoring the received candidate applications based at least in part on a review of the submitted applications.

Other aspects and advantages of the invention will become apparent from the following drawings, detailed description, and claims, all of which illustrate the principles of the invention, by way of example only.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a block diagram of an embodiment of a distributed software development system having a server according to the invention.

FIG. 2 is a block diagram of one embodiment of a software development domain according to an embodiment of the invention.

FIG. 2A is a block diagram depicting the components of a software application according to one embodiment of the invention.

FIG. 3 is a flow chart depicting steps performed in developing a software program according to an embodiment of the invention.

FIG. 3A is a flow chart depicting an overview of the operation of an embodiment of the invention.

FIG. 4 is a flow chart depicting an overview of the operation of an embodiment of the invention.

FIG. 4A is a flow chart depicting an overview of the operation of an embodiment of the invention.

FIG. 5 is a block diagram depicting a software testing environment created with multiple submissions of test cases according to an embodiment of the invention.

FIG. 6 is a more detailed diagram of an embodiment of a testing environment such as that shown in FIG. 5.

FIG. 7 is a block diagram of an embodiment of a server such as that of FIG. 1 to facilitate the development and/or testing of software programs.

### DETAILED DESCRIPTION

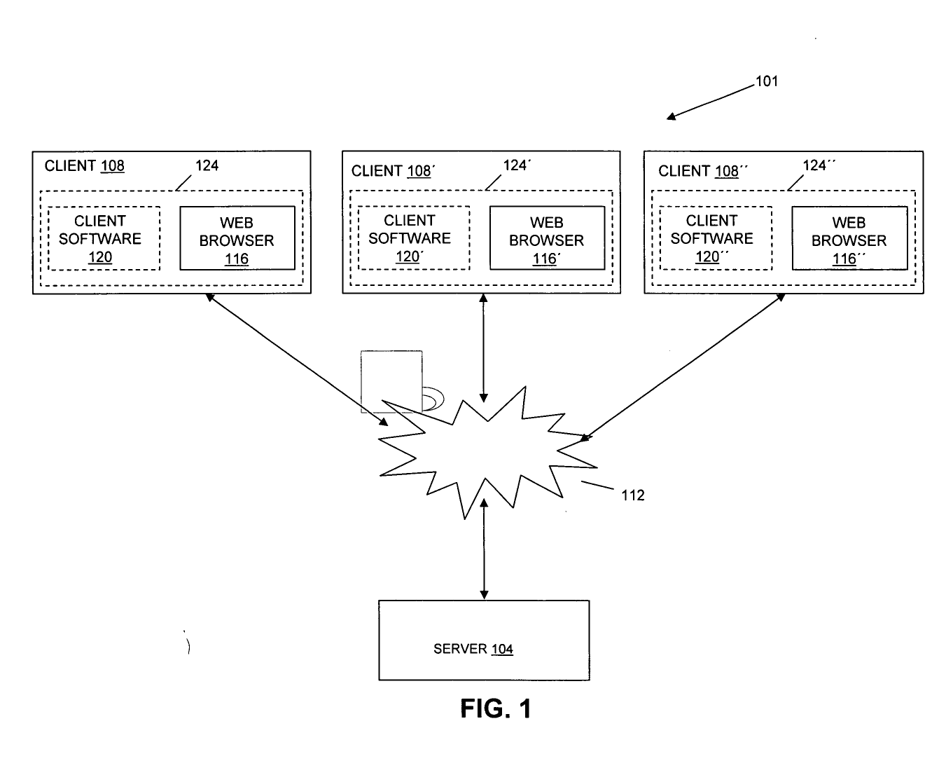

Referring to FIG. 1, in one embodiment, a distributed software development system 101 includes at least one server 104, and at least one client 108, 108′, 108″, generally 108. As shown, the distributed software development system includes three clients 108, 108′, 108″, but this is only for exemplary purposes, and it is intended that there can be any number of clients 108. The client 108 is preferably implemented as software running on a personal computer (e.g., a PC with an INTEL processor or an APPLE MACINTOSH) capable of running such operating systems as the MICROSOFT WINDOWS family of operating systems from Microsoft Corporation of Redmond, Wash., the MACINTOSH operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 108 could also be implemented on such hardware as a smart or dumb terminal, network computer, wireless device, wireless telephone, information appliance, workstation, minicomputer, mainframe computer, or other computing device, that is operated as a general purpose computer, or a special purpose hardware device used solely for serving as a client 108 in the distributed software development system.

Generally, in some embodiments, clients 108 can be operated and used by software developers to participate in various software development activities. Examples of software development activities include, but are not limited to software development projects, software design projects, testing software programs, creating and/or editing documentation, participating in programming contests, building applications, as well as others. Clients 108 can also be operated by entities who have requested that the software developers develop software (e.g., customers). The customers may use the clients 108 to review software developed by the software developers, post specifications for the development of software programs, test software modules, view information about the developers, as well as other activities described herein. The clients 108 may also be operated by a facilitator, acting as an intermediary between the customers and the software developers.

In various embodiments, the client computer 108 includes a web browser 116, client software 120, or both. The web browser 116 allows the client 108 to request a web page or other downloadable program, applet, or document (e.g., from the server 104) with a web page request. One example of a web page is a data file that includes computer executable or interpretable information, graphics, sound, text, and/or video, that can be displayed, executed, played, processed, streamed, and/or stored and that can contain links, or pointers, to other web pages. In one embodiment, a user of the client 108 manually requests a web page from the server 104. Alternatively, the client 108 automatically makes requests with the web browser 116. Examples of commercially available web browser software 116 are INTERNET EXPLORER, offered by Microsoft Corporation, NETSCAPE NAVIGATOR, offered by AOL/Time Warner, or FIREFOX offered the Mozilla Foundation.

In some embodiments, the client 108 also includes client software 120. The client software 120 provides functionality to the client 108 that allows a software developer to participate, supervise, facilitate, or observe software development activities described above. The client software 120 may be implemented in various forms, for example, it may be in the form of a Java applet that is downloaded to the client 108 and runs in conjunction with the web browser 116, or the client software 120 may be in the form of a standalone application, implemented in a multi-platform language such as Java or in native processor executable code. In one embodiment, if executing on the client 108, the client software 120 opens a network connection to the server 104 over the communications network 112 and communicates via that connection to the server 104. The client software 120 and the web browser 116 may be part of a single client-server interface 124; for example, the client software can be implemented as a “plug-in” to the web browser 116.

A communications network 112 connects the client 108 with the server 104. The communication may take place via any media such as standard telephone lines, LAN or WAN links (e.g., T1, T3, 56 kb, X.25), broadband connections (ISDN, Frame Relay, ATM), wireless links (802.11, bluetooth, etc.), and so on. Preferably, the network 112 can carry TCP/IP protocol communications, and HTTP/HTTPS requests made by the web browser 116 and the connection between the client software 120 and the server 104 can be communicated over such TCP/IP networks. The type of network is not a limitation, however, and any suitable network may be used. Non-limiting examples of networks that can serve as or be part of the communications network 112 include a wireless or wired ethernet-based intranet, a local or wide-area network (LAN or WAN), and/or the global communications network known as the Internet, which may accommodate many different communications media and protocols.

The servers 104 interact with clients 108. The server 104 is preferably implemented on one or more server class computers that have sufficient memory, data storage, and processing power and that run a server class operating system (e.g., SUN Solaris, GNU/Linux, and the MICROSOFT WINDOWS family of operating systems). Other types of system hardware and software than that described herein may also be used, depending on the capacity of the device and the number of users and the size of the user base. For example, the server 104 may be or may be part of a logical group of one or more servers such as a server farm or server network. As another example, there could be multiple servers 104 that may be associated or connected with each other, or multiple servers could operate independently, but with shared data. In a further embodiment and as is typical in large-scale systems, application software could be implemented in components, with different components running on different server computers, on the same server, or some combination.

In some embodiments, the server 104 also can include a contest server, such as described in U.S. Pat. Nos. 6,569,012 and 6,761,631, entitled “Systems and Methods for Coding Competitions” and “Apparatus and System for Facilitating Online Coding Competitions” respectively, both by Lydon et al, and incorporated by reference in their entirety herein.

In one embodiment, the server 104 and clients 108 enable the distributed software development and/or assembly of a software program by one or more developers, which developers may or may not be associated with the entity requesting the development of the software program. The software program can be any sort of instructions for a machine, including, for example, without limitation, a component, a class, a library, an application, an applet, a script, a logic table, a data block, or any combination or collection of one or more of any one or more of these.

In one embodiment, the software program is a software component. Generally, a software component is a functional software module that may be a reusable building block of an application. A component can have any function or functionality. Just as a few examples, software components may include, but are not limited to, such components as graphical user interface tools, a small interest calculator, an interface to a database manager, calculations for actuarial tables, a DNA search function, an interface to a manufacturing numerical control machine for the purpose of machining manufactured parts, a public/private key encryption algorithm, and functions for login and communication with a host application (e.g., insurance adjustment and point of sale (POS) product tracking). In some embodiments, components communicate with each other for needed services (e.g., over the communications network 112). A specific example of a component is a JavaBean, which is a component written in the Java programming language. A component can also be written in any other language, including without limitation Visual Basic, C++, Java, and C^{#}.

In one embodiment, the software program is an application. The application may be comprised of one or more software components. In one embodiment, the software application is comprised of software components previously developed using the methods described herein. In some embodiments, the application comprises entirely new software programs. In some embodiments, the application comprises a combination of new software programs and previously developed software programs.

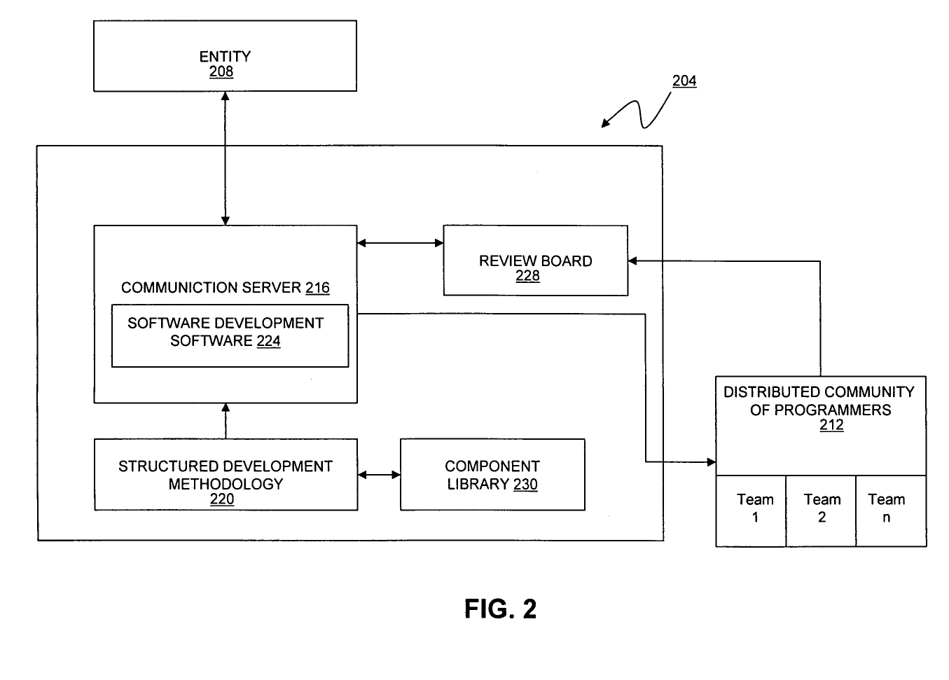

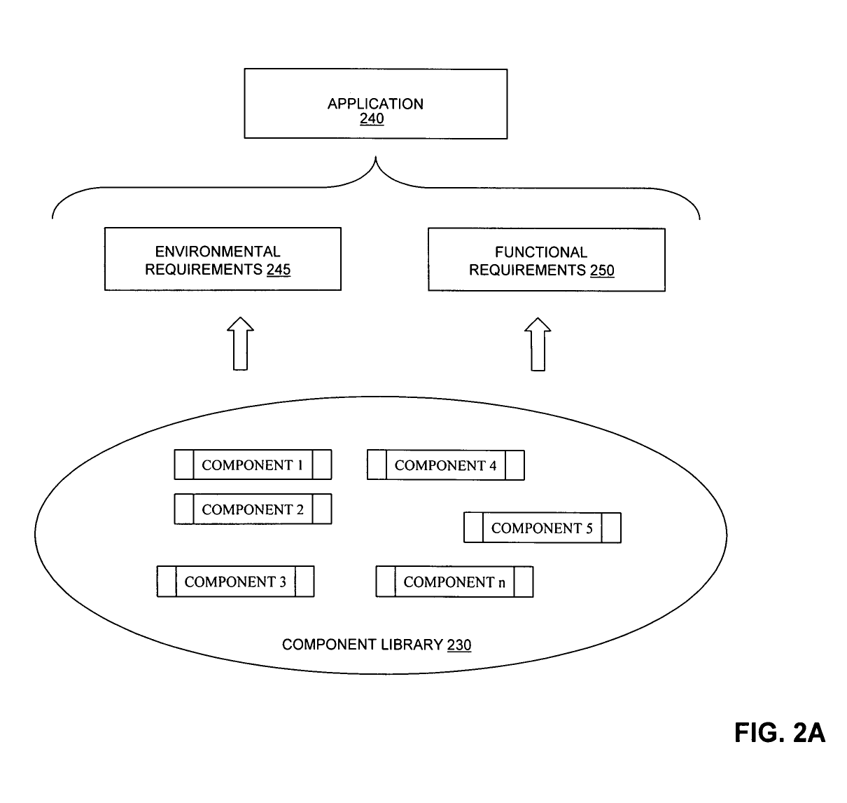

Referring to FIG. 2, a software development domain 204 can be used to provide an entity 208 with high-quality software. One or more developers can be identified and/or selected by various methods from a distributed community of programmers 212, and subsequently used to develop software components. For example, the developers can be employees of, consultants to, or members of an organization, enterprise, or a community fostering collaborative computer programming and distributed software development, and in some cases the developers may have no other formal or informal relationship to each other. In some embodiments, one or more of the developers can act as a product manager who is responsible for organizing and coordinating the efforts of other developers. The product manager may also specify items such as, without limitation, the cost of the project, the project schedule, and the project risks. In one embodiment, the product manager creates a project plan for the project, which may include, without limitation, an estimated project cost and schedule, and a requirements document describing, for example, the scope and risks of the project. The project manager may also be responsible for assembling a team of software developers to work on the project. For example, the project manager may receive requests to participate in the project from one or more developers, and/or may review developer profiles to identify those developers that the project manager wants to include on a team. The project manager may organize multiple teams. In some embodiments, the developers may include architects, designers, programmers, quality assurance engineers, as well as other software development roles as described in co-pending U.S. patent application Ser. No. 10/408,402, entitled “Method and Systems for Software Development” by Hughes, and incorporated by reference in its entirety herein.

In one embodiment, the software development domain 204 includes a communication server 216, one or more structured development methodologies 220, software development software 224, and an a review board 228, and a component library 230. The communication server provides a conduit through which the external entity 208, the community of programmers 212, and the review board 228 can interact, for example, to provide documentation, submit software, elicit and offer feedback, review submitted software, and potentially rate submitted software, either in design or functional form. In some embodiments, the communication server is or operates as part of the server 104 as described above, whereas in other cases the communication server may be a separate server, which may be operated by and/or outsourced to an application service provider (ASP), internet service provider (ISP), or other third-party.

The structured development methodology 220 provides a framework for the development of software programs. The methodology 220 specifies a common vocabulary, a fixed set of deliverables, development phases or steps, inputs and outputs for one or more of the steps, as well as other aspects of the development process. For example, the methodology 220 bifurcates the development process into an architecture and design phase and a development and testing phase. Furthermore, in this particular non-limiting example, the outputs of the architecture and design phase, such as class diagrams, test cases, technical specifications, and other design documents, are submitted, reviewed, and finalized prior to initiating any development work. Once a set of design documents are selected and approved, the design documents are used as input into the development phase. During the development and testing phase, the developer(s) create source code, scripts, documentation, and other deliverables based on the design documents. In instances where the deliverable is an application, the developer(s) assemble an application using various combinations of previously developed components and/or new components, based on the design specification for the application. By assuring the high-quality of the design documents and/or the components prior to beginning development, the developers are afforded a complete and accurate representation of what it is they are being asked to develop. Furthermore, by using a structured methodology, the participants, (e.g., developers 212, the entity 208) can communicate effectively, and the outputs of each process step are known and can be verified. By providing a common definition, and a known set of inputs, such as use cases, and a known set of outputs such as expected results, and facilitating community-based development, the developers can interact with each other effectively and efficiently, thus reducing the cost and time necessary to produce quality software.

The software development software 224 provides an operational mechanism for implementing the methodology 220, and a software development environment in which the developers can do one or more of develop, test, submit, assemble and verify software designs and software programs. In some embodiments, as shown, components of the software 224 may reside on the server 104, whereas some components may be included in client software residing on a client, e.g., as described above. The software development software 224 optionally can include one or more such as a development library, from which developers can access previously developed components and documentation templates; a documentation feature that provides information about programming terms, syntax, and functions; a compiler that also allows a developer to identify and correct programming errors; and even version control and code management functions.

The component library 230 may include components from the current competition and components resulting from previously completed competitions. In one embodiment, the component library 230 provides a catalog or directory of information about the components available to contestants participating in the current contest. For instance, a participant can view a directory of the component library 230 and information about each component in the component library 230 to determine which component or components are appropriate for inclusion into an application being developed as part of a contest. The component library 230 may also include test cases and documentation for each component, such as, but not limited to, the component's memory requirements, efficiency, score received in QA testing, revision number, number of times deployed in an application, and the names of handles of the programmers that designed and/or developed the component.

FIG. 2A provides a general illustration of the development of an application 240 using the methods and systems described herein. The requirements for the application 240 can generally be classified as environmental requirements 245 and functional requirements 250. Examples of environmental requirements include, as examples only, the intended operating system or platform (e.g., .Net, J2EE) on which the application will be deployed, memory requirements or limitations, communication protocols supported, availability targets, and others. Functional requirements 250 generally describe the operational and processing tasks that the application is expected to perform, such as data extraction and collection, computational requirements, transaction processes, user interface forms, and others.

In cases where components have previously been developed (and, for example, are stored in a component library 230) an application may be assembled by selecting the appropriate components that perform each task given the specific requirements, such as those described above. For example, a customer service application may include functional components such as a telephony integration component for interacting with a telephone system, a data query component for supplying data to the application based on one or more query parameters, a user-input component for generating an input screen for data capture, as well as others. By employing the structured development methodologies described herein, each of the various components are likely to have been developed using similar coding and architectural guidelines, and thus are likely to be compatible with each other with little or no modifications. Thus, the assembly of the application can be completed in significantly less time (and at a lower cost) than using traditional programming methods.

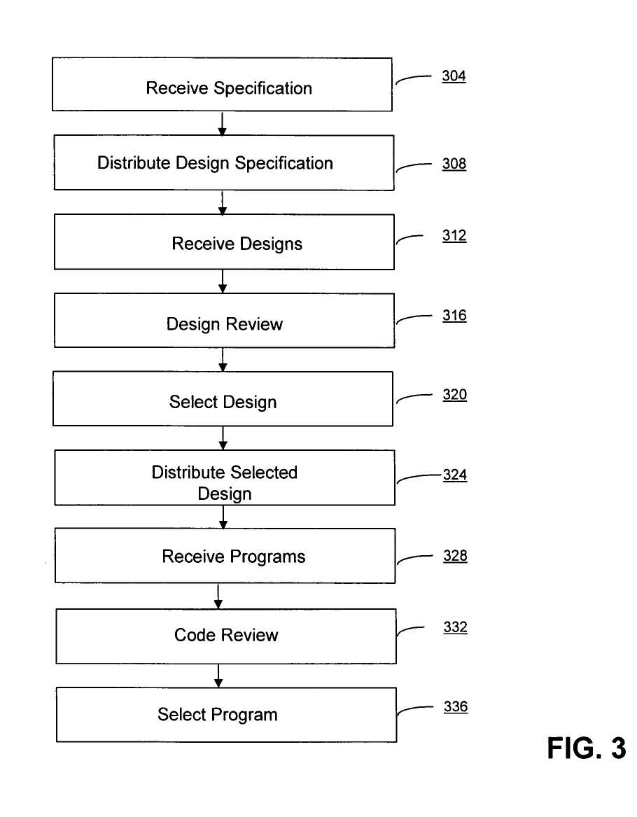

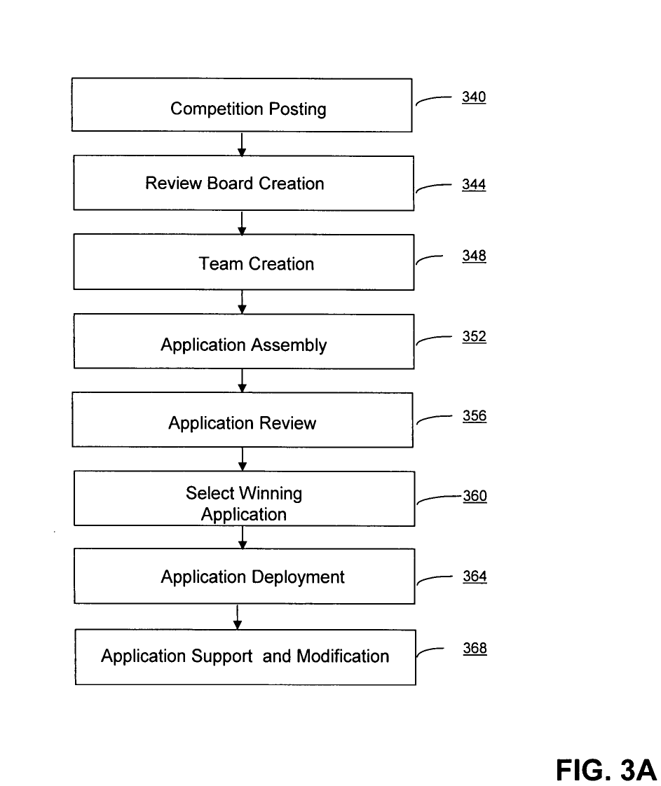

FIG. 3 provides a summary illustration of one embodiment of a method for developing software, for example, using the software development domain 204 described above. The communication server 216 receives a specification (STEP 304) describing the desired functions of a software program, which is then distributed to the distributed community of programmers 212 (STEP 308). One or more of the programmers in the community 212 creates a design detailing the technical aspects of the program based on the functionality described in the specification, and once completed, the design(s) are received at the server 104 (STEP 312). The submitted design(s) are then subject to a design review process (STEP 316) whereby the design(s) are compared to the specification, and evaluated on their implementation of the specified functionality, use of existing components, and compliance with the structured development methodology 220. A design that is the “best” of the submissions may be selected in response to the evaluations (STEP 320), and if there is at least one submission of sufficient quality, the selected design may be made available to the distributed community of programmers 212 (STEP 324). Each of a number of programmers (or, in some cases, each of teams of programmers) submits a software program that they believe conforms to the design and the requirements of the structured development methodology 220. The software programs are received at the server 104 (STEP 328) and the programs are subjected to a software review process (STEP 332) to determine which submitted program(s) best conform to the distributed design and the structured development methodology 220. Once reviewed, one (or in some cases more than one, or none if none are of sufficient quality) program is identified as a “winning” submission (STEP 336).

FIG. 3A provides one example of an implementation of the methods described above as applied to the assembly of an application. The communication server 216 posts competition details and an application specification (STEP 340) describing the parameters of the competition (e.g., start and end dates, payments, etc.) and the requirements for the application (e.g., the components required to be included in the application, the environment in which the application is to operate, etc.). Either prior to, simultaneously, or after the posting of an application competition, a review board is created (STEP 344) and teams are formed (STEP 348).

The review board 304 includes one or more developers who answer questions during the assembly process and review the completed applications as they are submitted. The review board preferably has a small number of (e.g., less than ten) members, for example, three members, but can be any number. Generally, the review board is formed for only the development of one application, although the review boards can be allocated to multiple application competitions as warranted. In one embodiment, the review board is open to members of the general public. In another embodiment, the review board is limited to software developers who have participated in at least one design, coding or application competition and are optionally pre-qualified based on their competition performance. In another embodiment, only the excellent developers as established in one or more competitions are eligible for participation in the review board.

Preferably, one of the review board members is selected, by the entity, a contest facilitator, other members of the review board, or otherwise, to be a primary review board member. If the board is instituted for multiple application assembly contests, typically, a primary review board member is assigned for each application, but the primary review board member also can be the same for all applications reviewed by that board, depending on the availability and skills of the members. The primary review board member is responsible for coordination and management of the activities of the board. The review board may be comprised of one or more programmers that have achieved sufficient ratings or rankings based on their involvement in previous review boards, and/or as contestants in one or more application or component design or development contests.

In step 348, one or more teams are created to facilitate collaboration among the members of the community of programmers to develop applications. In some embodiments, team creation forums are used to solicit participation requests from developers and potential project managers and to facilitate the formation of teams. Teams may sign up as a whole (e.g., a group of developers can decide to participate as a group prior to the announcement of a contest and indicate that they wish to form a team), whereas other developers may sign up as individuals and act as “free agents” that are available to any team needing additional developers.

In some cases, limitations may be placed on the number of team members a team may have, and/or the number of teams on which a developer may participate. Alternatively or in addition, a team captain may “bid” on particular developers to entice the developer to join her team (based, for example, on a particular developer's high rating, successful completion of previous projects, and/or a prior experience with that particular developer). The bidding may include offering the developer greater responsibilities on the project team, a higher share of the prize and the like.

Once the teams are created and the competition starts, each team begins the process of application assembly (STEP 352). Each of the teams participating in the competition creates a complete application using the necessary components as detailed in the specification. In some embodiments, each team has a working environment, which, in some cases may include the components being used to assemble the application, various versions and/or sub-assemblies of the application, and one or more discussion forums to facilitate team communication. The forums can be monitored by the competition facilitator to allow for real-time questions, requests for additional components, and resolution of other issues. As the application (or portions thereof) nears completion, test cases are provided such that the team members can test various functional elements of the application. Once the team is satisfied that their application meets the posted specifications, the application is submitted to the server 104. The submitted application(s) are then subject to an application review process (STEP 356) whereby the applications(s) are compared to the specification, and evaluated on their implementation of the specified functionality, use of existing components, and compliance with the structured development methodology 220. For example, the application may be tested by deploying the application on a test server and running a suite of test cases against the application. An application that is the “best” of the submissions may be selected in response to the evaluations (STEP 360) and the application is identified as a “winning” submission.

In some embodiments, a scorecard is used to determine which application is the best of the submitted applications. The scorecard can be a document, spreadsheet, online form, database, or other electronic document which may or may not be provided to the team. In some cases, the team can initiate an appeal contesting the score assigned to the team's application.

Once a final determination of the winning application has been made, the application is approved (either by the entity, a facilitator acting as a project manager, or in some cases both) and the application is deployed (STEP 364).

In some embodiments, the team continues to support the application during the deployment phase. For example, the entity sponsoring the application assembly may include contingencies such that only a portion of the prize is paid to the winning team upon deployment, and the balance of the prize is paid after some period (e.g., thirty days) during which the team is available to modify the application if necessary (STEP 368). In some cases, changes may be deemed to be enhancements (i.e., desired functionality that was not part of the original specification) and additional fluids may be provided for adding such features. In other cases, defects may be identified that cause the application to fail, incorrectly perform some process, or otherwise not conform to the specification. During the deployment phase, the defects may be assigned to the team captain, for example, who either fixes the defect or assigns the defect to a particular team member. In some embodiments, deadlines are assigned to fixing defects, and some of the remaining prize money may be deducted from the payments based, for example, on whether a defect can be fixed and if the fix is delivered according to its stated deadline.

If, as may happen, a defect is determined to be part of a component from which the application was assembled (e.g., a component does not work as described) the component may submitted to a component support process, as described in U.S. patent application Ser. No. 11/311,911 by Hughes, which is incorporated by reference in its entirety herein.

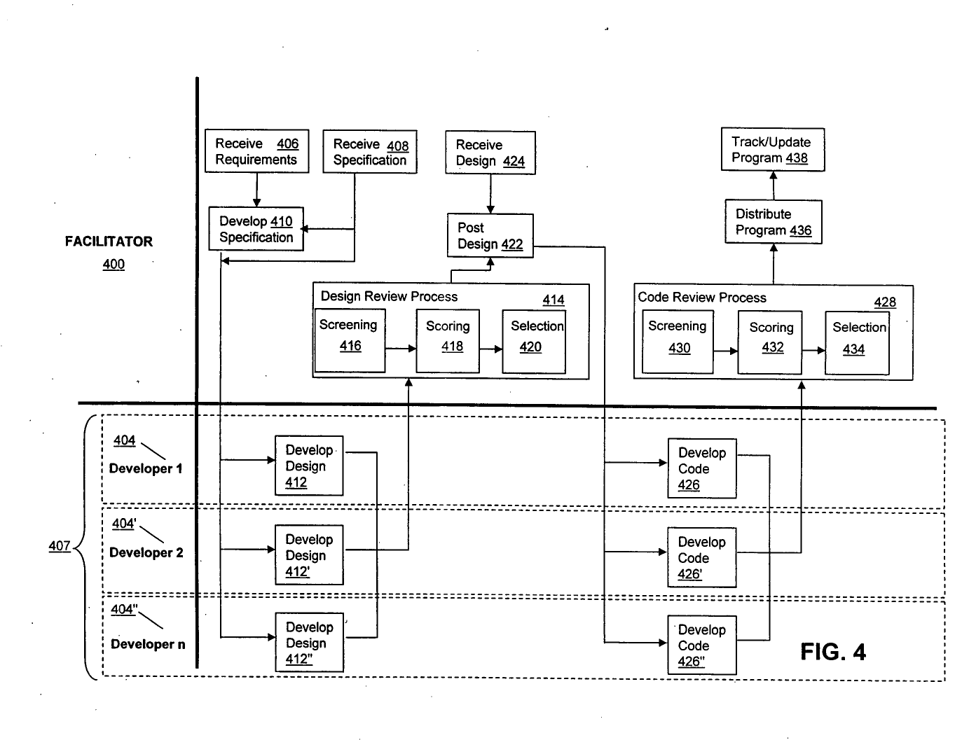

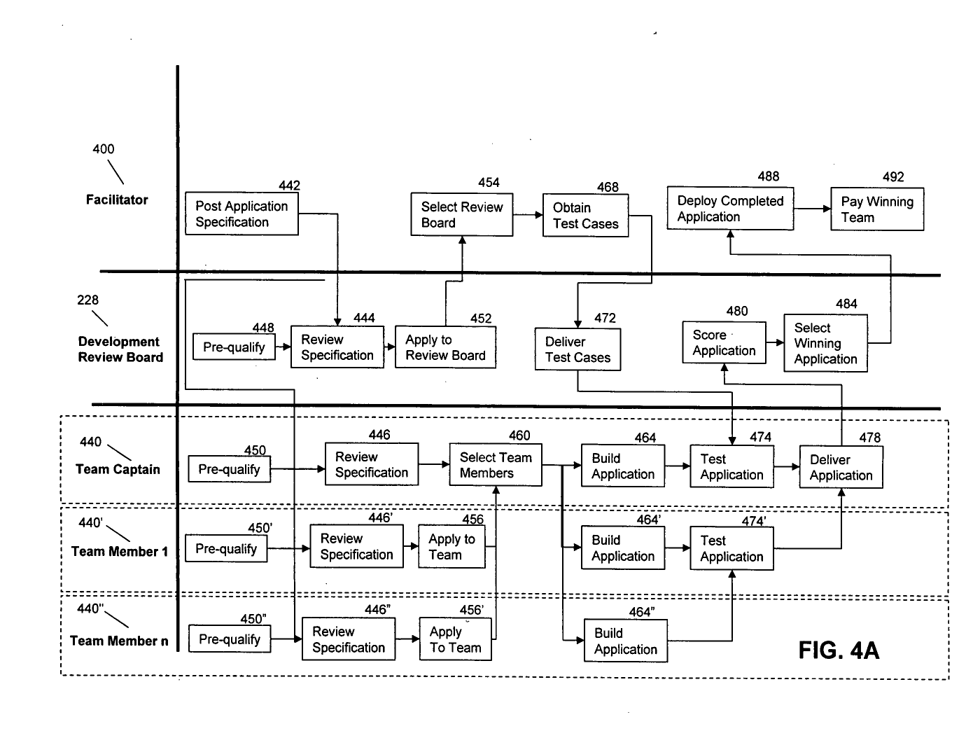

FIG. 4 provides one possible implementation of the general method described above. In some such embodiments, the development process is monitored and managed by a facilitator 400. The facilitator 400 can be any individual, group, or entity capable of performing the functions described here. In some cases, the facilitator 400 can be selected from the distributed community of developers 208 based on, for example, achieving exemplary scores on previously submitted software designs and/or programs, or achieving a high ranking in a software programming contest. In other cases, the facilitator 400 can be appointed or supplied by the entity (e.g., entity 208) requesting the development of the software program, and thus oversee the design and development process for further assurance that the end product will comport with the specifications.

Initially, the facilitator 400 receives input from an entity (not shown) wishing to have a software program, application, component, or other asset developed on their behalf. The entity can be a company looking to have one or more computer programs designed and/or developed for internal use, or as portions of larger applications that they intend to sell commercially. In some cases, the entity provides a detailed specification, and in other cases only a list of functional requirements may be provided. The facilitator receives either the requirements (STEP 406), the specification (STEP 408), or in some cases both from the external entity. If, however, no specification is provided, or of the specification needs revisions to conform to the methodology, the facilitator can develop a specification in accordance with the requirements (STEP 410). In some cases, one or more members of the development community 407 (e.g., development community 212 in FIG. 2) may be asked to develop the specification, and in some cases multiple specifications may be submitted, with one of the submissions selected as the final specification to be used for guiding the design and development efforts.

In one embodiment, the specification defines the business plan and a stable hardware and/or software platform, or other architectural constraints. For example, the specification can define the network devices, servers, and general infrastructure to support the development and production of the project and product. The specification can also identify a language or tools that the component must be programmed in or with, a functional overview of the software component, boundary conditions, efficiency requirements, computer platform/environment requirements, interface requirements, performance criteria, test-case requirements, and/or documentation requirements of the component. In some embodiments, the specification can include an amount of money that will be paid to the designer who submits the best design and/or program that complies with the specification.

In some cases, the specification is assigned a difficulty level, or some similar indication of how difficult the facilitator, entity, or other evaluator of the specification, believes it will be to produce a comprehensive design according to the specification. The difficulty level may, in some cases, also be based on the effort believed to be necessary to complete the task, and the time allotted to complete the task. The difficulty level may be expressed in any suitable manner, for example as a numerical measure (e.g., a scale of 1 to 10), a letter grade, or a descriptive such as easy, medium, or hard. For example, a specification for the design of a complex gene-sequencing algorithm may have a difficulty level of 9 on a scale of 1 to 10, whereas a simple component that performs a search for specific text in a file may be assigned a difficulty level of 2. If there are additional practical constraints, for example if the search component is needed in two days, the difficulty level optionally may be increased due to the tight time constraints. In some embodiments, an award to the designer (e.g., money, skill rating, etc.) that submits the selected design may be produced or adjusted based in part on the difficulty level associated with the specification.

Once the specification is received (or developed), the facilitator 400 (or in some cases a project manager) reviews the specification to determine if it meets the requirements for a complete specification according to the development methodology 220. The methodology can include best-practice activities, templates, guidelines, and standards that assist software architects, programmers, and developers in producing quality code in a consistent and efficient manner. The use of such a methodology reduces the need to rethink and recreate programming documentation and constructs, thus reducing project duration, cost, and increasing quality and component reusability.

Once complete, the specification is distributed via the communications server 212 to one or more developers 404, 404′, 404″ (generally, 404), who may be members, for example, of a distributed community of programmers such as the community 212 shown in FIG. 2. In one non-limiting example, the developers 404 are unrelated to each other. For example, the developers may have no common employer, may be geographically dispersed throughout the world, and in some cases have not previously interacted with each other. However, as members of the community 212, the developers 404 may have participated in one or more competitions, and/or have had previously submitted software artifacts subject to reviews. This approach allows an entity 208 to gain access to a large pool of qualified software developers.

The communication can occur over a communications network such as the network 112 (FIG. 1), such as via an email, instant message, text message, a posting on a web page accessible by the web browser 116, through a news group, facsimile, or any other suitable communication. In some embodiments, the communication of the specification can be accompanied by an indication of a prize, payment, or other recognition that is available to the designer(s) that submit selected software design(s). In some cases, the amount and/or type of payment may change over time, or as the number of participants increases or decreases, or both. In some cases multiple designers may be rewarded with different amounts, for example a larger reward for the best design, and a smaller reward for second place. The number of designers receiving an award can be based on, for example, the number of designers participating in the design project, or other similar attributes.

The recipients of the specification can be selected by various means. In some embodiments, members of the community may have expressed interest in participating in a development project, whereas in some cases the individuals are selected based on previous performances in coding competitions, prior development projects, or other methods of measuring the programming skill of a software developer. For example, the members of the distributed community of programmers may be programmers who have previously participated in an on-line programming competition. In such a case, the programming skills of the participants may have been rated according to their performance, either individually, as a team, or in relation to other programmers, and the ratings may be used to determine which programmers are eligible to receive notification of a new specification or respond to a notification. In some embodiments, the developers 404 may form teams and participate in the design and/or development contest as a group.

In one embodiment, the facilitator 400 moderates a collaborative forum among the various participants (the external entity 208, the developers 404, etc.) to determine, discuss, or collaborate on design features. The collaborative forum can consist of developers, customers, prospective customers, or others interested in the development of certain software. In one embodiment, the collaboration forum is an online forum where participants can post ideas, questions, suggestions, or other information. In some embodiments, only a subset of the forum members can post suggestions to the forum. In instances where team-based participation is permitted, there may be separate “private” forums to which only team members have access, as well as a competition-wide forum that is open to all participants.

Upon receipt of the specification, one or more developers 404 each develop software designs (STEPS 412, 412′ and 412″) in accordance with the specification. The development of the software design can be done using any suitable development system, for example, the software development software 224 provided via the communication server 216, a development environment provided by the developer 404, or some combination thereof. Once a developer 404 is satisfied that her design meets the specified requirements, and follows the structured development methodology 220, she submits her design e.g., via the communications server 216, facsimile, email, mail, or other similar methods.

To determine which design will be used as the design for the software program, a design review process (STEP 414) is used. This design review can take place in any number of ways. In some cases, the facilitator 400 can delegate the review process to one or more members of the distributed community of programmers, or an appointee of the entity. The design review process, in some embodiments, includes one or more developers 404 acting as a design review board to review design submissions from software designers. The design review board preferably has a small number of (e.g., less than ten) members, for example, three members, but can be any number. Generally, the review board is formed for only one or a small number of related projects, for example three projects. Review boards, in some embodiments, could be formed for an extended time, but changes in staffing also can help maintain quality.

Preferably, one member of the design review board members is selected as the primary review board member by the facilitator 400 and/or the project manager, the members of the review board, and/or the external entity requesting the software program. In some cases, the facilitator 400 or a representative of the facilitator 400 acts as the primary review board member. The primary review board member is responsible for coordination and management of the activities of the board.

In one embodiment, submissions for software designs are judged by the design review board. In some embodiments, the primary review board member screens the design submissions before they are reviewed by the other members of the design review board, to allow the rest of the review board to judge only the best of the submissions. In some embodiments, the screening process includes scoring the submissions based on the degree to which they meet formal requirements outlined in the specification (e.g., format and elements submitted). In some embodiments, scores are documented using a scorecard, which can be a document, spreadsheet, online form, database, or other electronic document. The design review board may also, in some cases, verify the anonymity of the developers 404 such that their identities cannot be discerned from their submissions.

A screening review can determine whether the required elements of the design are included (e.g., class, use-case, and sequence diagrams, component specification, required algorithms, class stubs, and functional tests). The screening review can also determine that these elements appear complete. With regard to the class diagram, for example, and in particular the class definition, the screening review can determine any or all of that: (1) the class definition provides a descriptive overview of the class usage, (2) sub-packages have been created to separate functionality, (3) class scope matches class usage, (4) there is proper and effective use of programming techniques such as inheritance and abstraction, (5) interfaces are used properly, (6) suitable constructors are defined for the component, and that (7) class modifiers such as final and static, are appropriately used. The screening review can also determine, for example, with regard to variable definitions, that: (1) variable scope is correctly defined, (2) type assignments are defined appropriately for balance between efficiency and flexibility, and (3) that all variables are defined with an initial value. Further, with regard to method definitions, for example, the screening review can determine that: (1) scope is correctly defined, (2) exceptions are handled and used appropriately, (3) modifiers are properly used, (4) return types are used, (5) method arguments are properly defined, and (6) that the application programming interface (API) as stated in the requirements specification is available.

The screening review can also, for example, verify that use-case diagrams exist for all public methods in the design, and that sequence diagrams exist for each use case. The screening review can also, for example, with regard to test cases, verify that functional test cases are provided for each sequence diagram, and that they appear to be appropriate for those diagrams. The designs can take a number of forms, depending on the program specified. Typically, the specifications will include the requirements for the design. In one embodiment, the design requirements include class diagrams, which can be developed in the Unified Modeling Language (UML), for example using the Poseideon Computer Aided Software Engineering (CASE) tool, available from Gentleware AG of Hamburg, Germany. The design requirements also include use-case diagrams and sequence diagrams. The design requirements also include a written component design specification describing the design, a list of required algorithms, and class stubs for the classes in the design. The design requirements also include functional tests that can be used to test the program. In one such embodiment, the functional tests are tests compatible with the JUnit testing infrastructure. JUnit is open source software for testing Java software, which is available from www.sourceforge.net. In instances where the desired program is an application, the design requirements may also include specific components to be used in the design of the application, some of which may be identified as mandatory, whereas others may be deemed optional.

In one embodiment, the primary review board member informs the design review board that one or more submissions have passed the initial screening process (STEP 416), and the design review board then evaluates the design submissions in greater detail. In some embodiments, the design review board reviews the submissions based on requirements documented in the specification. In some embodiments, the design review board scores the submissions (STEP 418). In some embodiments, the scores are documented using a scorecard, which can be any form, including a document, spreadsheet, online form, database, or other electronic document.

In some embodiments, the scores and reviews from the primary review board member and the other members of the design review board are aggregated into a final review and score. In some embodiments, the aggregation can comprise compiling information contained in one or more documents. Such aggregation can be performed by the primary review board member, the other members of the design review board, or in one exemplary embodiment, the aggregation is performed using a computer-based system which resides on the server 104 (FIG. 1). In some embodiments, the facilitator 400 or the primary review board member resolves discrepancies or disagreements among the members of the design review board.

In one embodiment, the design with the highest combined score is selected as the winning design that will be used for implementation (STEP 420). A prize, payment and/or recognition is given to the designer. In one embodiment, a portion of the payment to the designer is withheld until the end of the development review. For example, the designer may receive 75% of the payment and the end of the design review, and 25% is paid after the code review. There can also be prizes, payments, and/or recognition for the other submitted designs. For example, the designers that submit the second and third best designs may also receive payment, which in some cases may be less than that of the winning designer. Payments may also be made for creative use of technology, submitting a unique test case, or other such submissions. In some embodiments, the software developers can contest the score assigned to their design, program, or other submissions.

In some cases, the posted design is assigned a difficulty level, or some similar indication of how difficult the external entity, facilitator 400 or some evaluator of the design, believes it will be to produce a software program or component that meets the requirements of the selected design. Like the difficulty levels assigned to the specification, the difficulty level assigned to a design may, in some cases, also factor in the effort believed to be necessary to complete the task, and the time allotted to complete the task. In some embodiments, the recognition awarded to the designer (e.g., money, skill rating, etc.) that submits the selected design may be adjusted based in part on the difficulty level associated with the specification.

In some embodiments, in addition to reviewing the submissions, the design review board can identify useful modifications to the design that should be included into the design prior to entering the development phase. The primary review board member documents the additional requirements, and communicates this information to the designer 404 who submitted the design. In one embodiment, the primary review board member aggregates the comments from the review board. The developer 404 can update the design and resubmit it for review by the design review board. This process can repeat until the primary review board member believes the design has met all the necessary requirements.

Once the design review board validates that a design has sufficiently addressed the requirements of the specification, the primary review board member notifies the facilitator 400, product manager, or external entity that such a design has passed the design review process. The design can then be posted and/or distributed (STEP 422) to the community of developers 407 to solicit submissions for software programs that conform to the design. For example, the facilitator 400 can make the design available on a web site and/or a mailing list for implementation, and request components according to the design.

In one alternative embodiment, and as an example of the flexibility of the system, the entity develops the software design and provides the design to the facilitator 400 as input directly into the development process. The facilitator 400 receives the design (STEP 424) and optionally initiates a review process as described above to confirm that the design meets the standards of the structured development methodology 220. Using this approach, an entity wishing to maintain control of the design phase of the software development process (e.g., architecture, platform, coding standards, etc.) can utilize internal or other resources such as business and systems analysts to develop a design that complies with their standards, and then utilize a distributed community of developers 212 to develop the end product. Generally, this alternative maintains the design aspects of the software development process in-house, and “outsources” the manufacturing aspects of the development process such that the development domain 204 can use repeatable, structured development methods and the community of developers 212 to develop the software programs. Similarly, the entity 208 may only require the services of the development domain 204 to develop a software design, and subsequently use other resources such as in house programmers or off shore developers to develop the code.

The flexibility provided by maintaining multiple entry and exit points into and out of the development process allows external entities to decide, on a case by case or phase by phase basis whether to utilize the development domain 204 from start to finish, (i.e., specification through testing and support) or only use the domain 204 for specific phases of the process (i.e., development of code, development of a specification, development of a software design, testing, support, etc.).

Referring still to FIG. 4, the selected and approved design is posted or provided to members of the distributed community of programmers 212. As above, with the specification, the design may be sent to the entire community or only selected members of the community. In versions where the design is sent to selected members, the selection process can be based on any or a combination of suitable criteria, for example, without limitation, past performances in programming competitions, the quality of previously submitted software programs, involvement in the development of the design, or by specific request of the facilitator 400, entity 208, the designer that submitted the winning design, other designers, or other members of the community 212. In some embodiments, the communication of the design can be accompanied by an indication of a prize, payment, or other recognition that is available to the developer or team of developers that submits a selected software program, and/or runners up. In some cases, the amount and/or type of payment may change over time, or as the number of participants increases or decreases.

Each developer 404 develops software code (STEPS 426, 426′, and 426″) meeting the requirements of the selected design, and when completed, submits the code for example to the facilitator 400 or the server. As described above, the developers 404 may use a variety of coding techniques, languages, and development environments to develop the software, so long as the code meets, for example, the functional and architectural aspects dictated by the design and the quality and syntactical standards outlined by the structured development methodology 220. In some embodiments, the developers 404 may use the software development software 224 provided via the communication server 216 to assist with the development tasks. Because the development software 224 and development methodology 220 are both maintained within the development domain 204, many of the coding and quality control requirements of the methodology 220 can be built into the software 224, further assisting the developers 404 to develop quality code in an efficient manner.

To determine which software program will ultimately be selected as the program to be delivered to the entity 208, a code review process (STEP 428) is used, which can take place in any suitable manner. The code review process, in some embodiments, includes one or more developers 404 acting as a code review board to review submitted software programs from software developers. The code review board preferably has a small number of members (e.g., less than ten), for example, three members, but can be any number. Generally, the code review board is formed for only one or a small number of related projects, for example three projects, and then disbanded to allow the members to participate in additional design review boards, code review boards, or participate as designers and/or developers themselves. Review boards, in some embodiments, could be formed for an extended time, but changes in staffing also can help maintain quality.

Preferably, one member of the code review board members is selected as the primary code reviewer by the facilitator 404 and/or the project manager, the members of the review board, and/or the external entity requesting the software program. In some cases, the facilitator 400 or a representative of the facilitator 400 acts as the primary code board member. The primary code board member is responsible for coordination and management of the activities of the board.

In one embodiment, submissions of software programs are judged by the code review board. In some embodiments, the primary review board member screens the code submissions before they are reviewed by the other members of the code review board, to allow the rest of the code board to judge only the best of the submissions, for example, those that meet minimal requirements. In some embodiments, the screening process includes scoring the submissions based on the degree to which they meet formal requirements outlined in the selected design (e.g., format and elements submitted). In some embodiments, scores are documented using a scorecard, which can be a document, spreadsheet, online form, database, or other electronic document.

In one embodiment, for example, with regard to software code, the code reviewer scores the code based on the extent to which: (1) the submitted code addresses the functionality as detailed in component design documents; (2) the submitted code correctly uses all required technologies (e.g. language, required components, etc.) and packages; (3) the submitted code properly implements required algorithms; (4) the submitted code has correctly implemented (and not modified) the public application programming interface (API) as defined in the design, with no additional public classes, methods, or variables; and (5) the submitted code makes use of previously developed components.

With regard to the source code, for example, the screening review can determine any or all of that: (1) all public methods are clearly commented; (2) required tags such as “@author,” “@param,” “@return,” “@throws,” and “@version” are included; (3) the copyright tag is populated; (4) the source code follows standard coding conventions for the Java language such as those published by Sun Microsystems; (5) a 4 space indentation is used in lieu of a tab indentation; and (6) all class, method and variable definitions found in the class diagram are accurately represented in the source code. The code review can also, for example, verify that unit test cases exist for all public methods in the design, and each unit test is properly identified by a testing program.

With regard to class definitions, for example, the reviewer can evaluate the code based on the extent to which classes are implemented as defined in design documents (including, for example, modifiers, types, and naming conventions), and whether defined classes are implemented. With regard to variable definitions and method definitions, for example, the reviewer can determine the extent to which all variables and methods are implemented as defined in the design documents (including, for example, modifiers, types, and naming conventions). With regard to relationships, for example, the reviewer can determine the extent to which the implementation properly maps class relationships.

The reviewer can further evaluate code based on a code inspection. For example, the reviewer can determine the extent to which the object types defined in the code are the best choices for the intended usage—for example whether a Vector type should have been used instead of an Array type. The reviewer can determine the extent to which there are any needless loops, or careless object instantiation or variable assignment.

The review can also inspect the test cases. With regard to test cases, for example, the reviewer can determine the extent to which (1) the unit test cases thoroughly test all methods and constructors; (2) the unit test cases properly make use of setup and teardown methods to configure the test environment; (3) files used in unit test cases exist in the designated directory; (4) unit test cases do not leave temporary files on the file system after testing is complete.

The reviewer can run tests on the code using test cases, for example test cases developed by the developer 404, other developers, the reviewers, the facilitator 400, the entity 208, as well as others. The reviewer can even further score the code by conducting accuracy, failure, and stress tests. Accuracy tests test the accuracy of the resulting output when provided valid input. Accuracy tests can also validate configuration data. Failure tests test for correct failure behavior when the component is provided with invalid input, such as bad data and incorrect usage. Stress tests test the component capacity for high-volume operation, but testing such characteristics as performance as throughput. The tests that fail are included in the evaluation of the component, for example as a score reduction. The reviewer can then assign an overall score to the component based on this evaluation.

In one embodiment, the primary review board member informs the code review board that one or more submissions have passed the initial screening step (STEP 430), and the code review board can then evaluate the program submissions in greater detail. In some embodiments, the code review board can review the submissions based on design requirements documented in the selected design. The code review board can then score the submissions (STEP 432) based on the results of the evaluations. In some embodiments, the scores are documented using a scorecard, which can be any suitable means, such as a document, spreadsheet, online form, database, or other electronic document.

In some embodiments, the scores and reviews from the primary code board member and the other members of the code review board are aggregated into a final review and score. In some embodiments, aggregation can comprise compiling information contained in one or more documents. Such aggregation can be performed by the facilitator 400, the primary code board member, the other members of the code review board or in one exemplary embodiment, the aggregation is performed using a computer-based system which resides on the server 104 (FIG. 1). In some embodiments, the facilitator 400 or the primary review board member resolves discrepancies or disagreements among the members of the code review board.

In one embodiment, the software program with the highest combined score is selected as the winning program (STEP 434) that will be delivered to the external entity 208 as a finished product (STEP 436). In some embodiments, a prize, payment and/or recognition is given to the software developer that submitted the winning program. There can also be prizes, payments, and/or recognition for the other submitted programs. For example, the programmers that submit the second and third best programs may also receive payment, which in some cases may be less than that of the winning programmer. Payments may also be made for creative use of technology, submitting a unique test case, or other such submissions. In some embodiments, the software developers can contest the score assigned to their programs, test cases, or other submissions.

In some embodiments, in addition to reviewing the submissions, the code review board can identify useful modifications to the program that should be included into a selected software program prior to distribution. The primary code review board member documents the additional requirements, and communicates this information to the developer 404 who submitted the code. In one embodiment, the primary code review board member aggregates the comments from the review board. The developer 404 can update the program and resubmit it for review by the code review board. This process can repeat until the primary review board member believes the program has met all the necessary requirements and meets the standards specified in the structured development methodology 220.

In some embodiments, the software may be updated with enhancements, post-delivery bug fixes, additional functionality, or modified to operate in additional computing environments or platforms after it has been delivered to one or more entity 208. In such cases, the domain 204 provides for the tracking and updating (STEP 438) of previously distributed software products, as described in co-pending U.S. patent application Ser. No. 10/408,402, entitled “Method and Systems for Software Development” by Hughes, filed on Apr. 7, 2003, and incorporated by reference in its entirety herein.

For example, in one embodiment, an entity commissions the development of a software component, and upon completion of the component, version 1 of the component is distributed to the entity 208. Subsequently, a second entity 208 requests the development of a similar component that performs the same functionality, however to meet the specific request of the second entity, some modifications are made to the component. A modification is, for example, an improvement (e.g., efficiency increase, smaller memory requirements), deletion (e.g., of an unneeded step or feature), and an addition (e.g., of a complimentary feature or function) to the component. Another example of a modification is the integration of the component into another component (e.g., a larger component). In response to the request for the modified component, a new version of the component (version 1.1, for example) is developed and distributed to the second entity 208. In one embodiment, a message is sent to the first entity 208 stating that an updated version of the component is available. In further embodiments, the costs for developing the newer version of the component can be shared among the recipients of the original component (version 1) who wish to receive the new version, as well as the entity that initiated the development of the new version. Additionally, in some embodiments the entity 208 that requested the development of the new version is compensated for licenses/sales of copies of the second version of the component.

Referring to FIG. 4A, a similar technique may be employed for the development of an application. The facilitator 400 posts (STEP 442) the application specification for review by members of the distributed community. In one embodiment, for example, the facilitator is acting as a product manager and places the application specification on a web server for access by the members of the community. The application specification is then reviewed by members of the community as potential review board members (STEPS 444) and as potential team members (STEPS 446, 446′ and 446″). In some cases, the application specification is only available to select members of the community, based, for example, on a prequalification phase (STEPS 448) in which the members achieve a particular rating or ranking within the community of developers based on previous competitions, for example.

Developers wishing to be selected as members of the review board apply (STEP 452) to the facilitator 400. In one embodiment, the review board members are selected by the facilitator 400 as a result of their expertise, their ratings, and their expressed willingness to participate in this capacity. In one embodiment, the review board members are selected after the applications are submitted to allow all developers an opportunity to participate as a team member. In one embodiment, the review board members are compensated for their participation in the review board. This compensation can be, for example, in the form of recognition, a flat or hourly fee, or a percentage of revenue generated by the application, a percentage of the prize for the winning application, or some combination.

Once the facilitator 400 selects the review board, the board members review the specification to better understand the development requirements for that particular application. The review board members can ask for clarification or revision of the specifications, and the facilitator 400 can respond. In this way, the review board can be sure to understand the requirements for the application that they will evaluate.

In some embodiments, prior to being granted access to the application specification, the software developers (also called programmers) 440, 440′ and 440″, generally 440, are also pre-qualified (STEPS 450, 450′ and 450″), which may be similar to that described above for the review board members (e.g., ratings, etc.) or otherwise. The facilitator 400, or a member of the review board, then grants those developers meeting the pre-qualification requirements access to the application specification. In some embodiments, access can be granted by a developer 440 entering a password, by a developer 440 navigating to a particular web page which checks the developer's qualifications, by the facilitator 400 emailing the specification to the developers 400, or other similar means. Once granted access to the specification, the developers 440 can then review the specification (STEPS 446, 446′ and 446″) and apply to a team (STEPS 456 and 456′). In some embodiments, one team member (in this case team member 440) is identified as a team captain, who may also be responsible for selected the team members (STEP 460). The selection of a team captain may be based on any criteria. For example, the team captain may be determined strictly on which developer volunteers first. In other cases, the team captain may be select my members of the team and/or members of the review board. In some cases, the team member having the highest rating may be automatically identified as the team captain.

In cases where a team is “over subscribed” (i.e., more developers want to participate on a particular team that there are spaces), the developers can submit additional information in an attempt to secure a space on the team. For example, the developer may direct the team captain's attention to a previous contest or project on which the developer worked and/or one or more components that the developer built. In some embodiments, developers may “bid” for spaces on the team by offering to participate for a lower percentage of the prize money. Likewise, in various embodiments a team captain may “bid” for members by varying the percentage of prize offered.

Each team member participates in the application assembly process (STEPS 464, 464′ and 464″). As described above, the application assembly process may include the identification of various pre-built software components that provide the functionality described in the application specification. In some embodiments, the components are pre-specified in the application specification, whereas in other cases the team determines which components to use. For example, an application needing to communicate information via web services over the internet may require a web server component, an XML parser, a database connectivity component, and a user interface component. Once the proper components are identified, the team members determine the proper arrangement of the components to accomplish the stated goals of the application, make any necessary modifications to the components, data definitions and/or environmental settings as well as performance tuning.

In some embodiments, the facilitator obtains a suite of test cases (STEP 468) to be applied to the application (or portions thereof) as it nears completion. The test cases may be previously submitted test cases that are specific to particular components from which the application is being assembled, or new test cases developed specifically for the application. In some cases, the test cases are developed using a similar “contest” approach. In general, developers are encouraged to develop test cases as they are coding so that they can consider the bounding and error conditions as they code. It can be beneficial to use the test cases developed by one or more, or all, of the other submitters to test each of the submitted programs to cover as many error conditions as possible. In some embodiments, the development of test cases is facilitated using the same techniques, systems, and methods described herein to design and develop software programs and applications. For example, a contest may be advertised to the community of developers that includes an application specification and the processing requirements associated with the application. Developers may then submit test cases for review by a review board. If the review board determines that the test case is useful (e.g., it tests for one or more conditions and no test case has been previously submitted that tests for that specific condition) the test case may be included in a test case suite for that application. The developer may then receive payments based on the extent to which the test case is used to test components, applications, or other software developed using the methods described herein.

In some embodiments, the review board 228 delivers the test cases (STEP 472) to the team and the applications are subjected to a team review process using the test cases in which the functionality of the application is tested (STEPS 474 and 474′). In some cases, not every team member participates in the testing process. The team review process allows team members to test, evaluate and review the pieces of the application being assembled by other team members. For example, one team member may be responsible for assembling all the components related to network connectivity and communications, whereas another team member may be responsible for assembling the components related to data exchange. As described above, the team members 440, 440′ and 440″ typically have minimal or no prior relationship to each other. In one exemplary embodiment, the team members are assigned (or select) on-line nicknames to be used instead of the their actual identities. Once the team has completed the application assembly and testing process (or, in some cases, the time limit to do so has been reached), the team (or in some cases the team captain) delivers the application to the review board (STEP 478) for review. Subjecting the applications to this independent and anonymous peer review process by other team members has a positive effect on the quality of the assembled application.

The review board 228 reviews the applications received from each team participating in the contest. In one embodiment, this review includes a first screening review by a primary reviewer, and then further review by other members of the review board 228. The first screening review determines, for example, that the required components have been used. The initial screening review can also, for example, verify that unit test cases exist for all public methods in the design, and each unit test is properly identified by a testing program. In one embodiment, the initial screening process reduces the number of entries to a manageable number for the review board 228 to review, such as five applications.

The review board evaluates the application against the application specification. In one embodiment, for example, with regard to the application, the reviewers evaluate the extent to which: (1) the application addresses the functionality as detailed in the specification; (2) the application correctly uses all required technologies (e.g. language, required components, etc.) and packages; and (3) the application has correctly implemented (and not modified) the public application programming interface (API) as defined in the design, with no additional public classes, methods, or variables.

The reviewer can even further evaluate the application by conducting accuracy, failure, and stress tests. Accuracy tests test the accuracy of the results output when provided valid input. Accuracy tests can also validate configuration data. Failure tests test for correct failure behavior when the application is provided with invalid input, such as bad data and incorrect usage. Stress tests test the application capacity for high-volume operation, but testing such characteristics as performance as throughput. The tests that fail are included in the evaluation of the application, for example as a score reduction. Each reviewer can then assign an overall score to the component based on this evaluation (STEP 480).

For example, the review board members can use the server 104 of FIG. 1 to record and communicate their evaluations of the applications to the other board members. In one embodiment, the board member uses an on-line evaluation form to evaluate each application. The evaluations of the board members can then be identified, and the applications automatically ranked by board member scores received. Based on the evaluation of the submission(s) the review board 228 selects an application as the winning submission (STEP 484).

Once identified, the winning application is approved (either by the entity that requested development of the application, a facilitator acting as a project manager, or in some cases both) and the application may be deployed (STEP 488). The environment into which the application is deployed may be, for example, a testing environment, a staging environment, or a live environment. In some embodiments, the team continues to support the application during the deployment phase as described above with reference to FIG. 3A. The winning team is then paid (STEP 492) according to the payment terms outlined at the beginning of the contest.

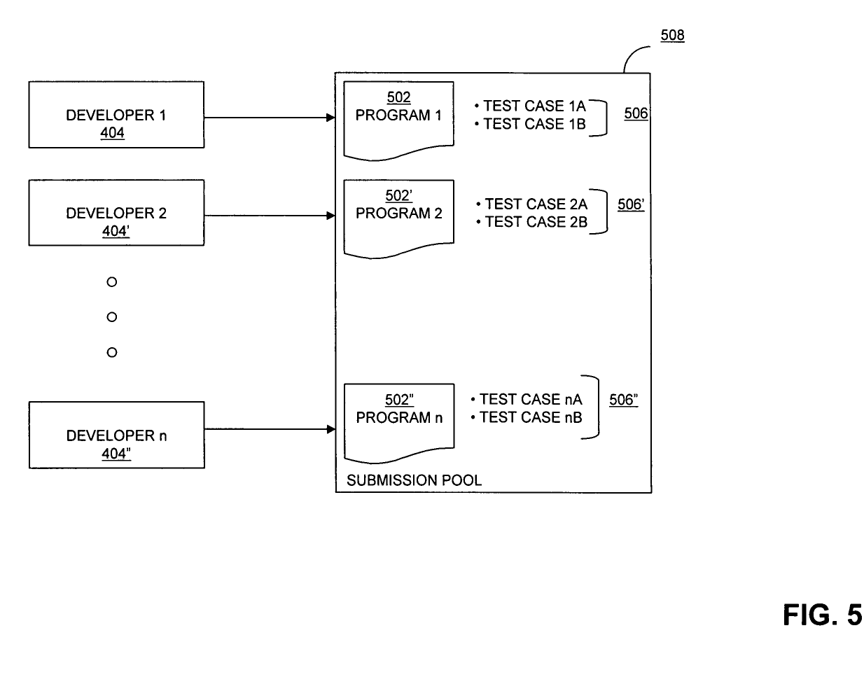

As mentioned above, and in reference to FIG. 5, the developers 404 may, in some embodiments, submit one or more test cases in addition to submitting the completed software program. The purpose of the test cases is to provide sample data and expected outputs against which the program can run, and the actual output of which can be compared to the expected outputs. By submitting multiple test cases, many different scenarios can be tested in isolation, therefore specific processing errors or omissions can be identified. For example, a program that calculates amortization tables for loans may require input data such as an interest rate, a principal amount, a payment horizon, and a payment frequency. Each data element may need to be checked such that null sets, zeros, negative numbers, decimals, special characters, etc. are all accounted for and the appropriate error checking and messages are invoked. In addition, the mathematical calculations should be verified and extreme input values such as long payment periods, daily payments, very large or very small principal amounts, and fractional interest rates should also be verified. In some versions, one test case can be developed to check each of these cases, however in other versions, it may be beneficial to provide individual test cases for each type of error. In certain embodiments, the multiple test cases can then be incorporated into a larger test program (e.g., a script, shell, or other high level program) and run concurrently or simultaneously.

In a demonstrative embodiment, developers 404, 404′ and 404″ each submit software programs 502, 502′ and 502″ respectively to the development domain 204 in response to the communicated software design and/or specification referred to above. In addition to submitting the programs, the developers 404 also submit one or more test cases 506, 506′, and 506″. For example, when DEVELOPER 1 404 submits PROGRAM 1 502, she also submits TEST CASE 1A and TEST CASE 1B, collectively 506. DEVELOPER 2 404′ and DEVELOPER 3 404″ do the same, such that after all three developers 404 have completed their submission, the development domain 204 includes a submission pool 508 comprising three submitted programs and six test cases. Even though it is likely that DEVELOPER 1 404 ran TEST CASE 1A and 1B 506 that she submitted against her PROGRAM 502, it is also possible that the test cases 506′ and 506″ submitted by DEVELOPER 2 404′ and DEVELOPER 3 404″ respectively address cases or data not contemplated by DEVELOPER 1 404. Therefore, it can be advantageous to run each test case submitted by all of the developers against each of the submitted programs in an attempt to identify all potential faults of each submitted program. In some versions, a subset of the submitted test cases may be eliminated from the submission pool 508, or not used, for example, because they are duplicative, do not test necessary features, or are incorrect. If so, a subset of the test cases in the submission pool 508 can be used to test the submitted programs. Because the programs are tested more rigorously (i.e., using a suite of test cases submitted by numerous developers) the quality of the resulting programs is likely to be greater than that of programs tested only by those that developed the selected program.

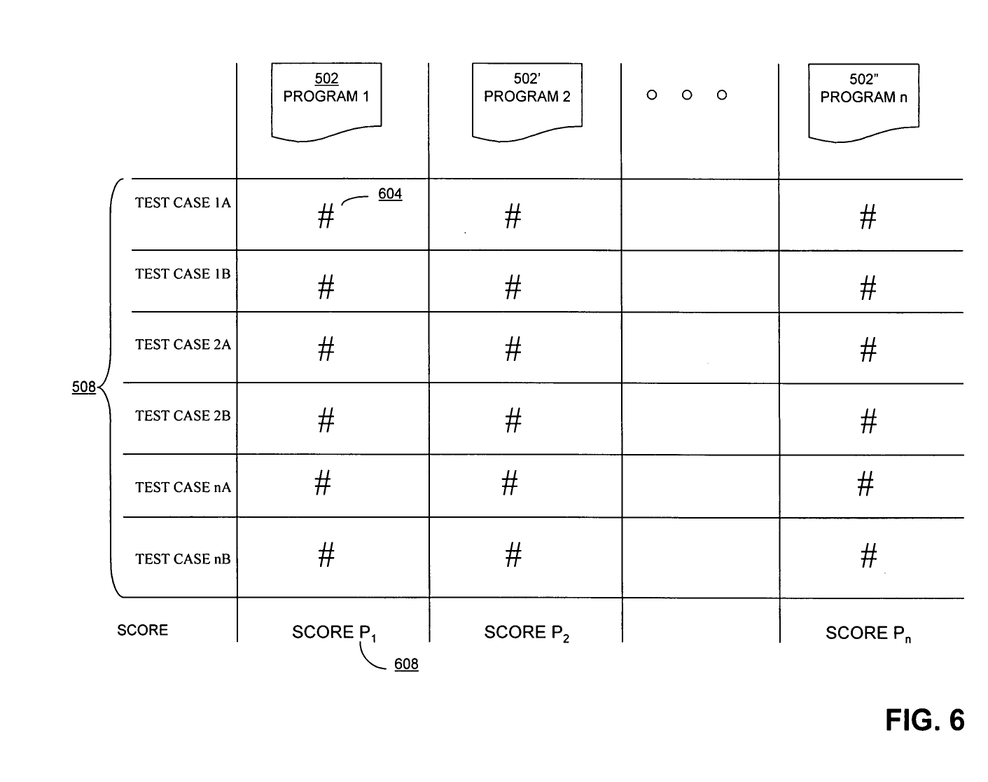

Referring to FIG. 6, the test cases in the submission pool 508 are applied to the submitted programs 502, 502′, 502″. In some cases, all of the test cases in the pool 508 are applied to every submitted program, whereas in some versions only a subset of the submitted test cases are used. In some embodiments, certain programs may be eliminated from contention by running a first test case against it, such that subsequent test cases are not necessary. In some versions, each application of test case to a program results in a score 604. The scores 604 for each application of test case to submitted program can then be tabulated and aggregated into a combined, or overall score for that particular program. Some test cases have a higher or lower weight than others such that the scores for a particular test case may be more indicative of the overall quality of the program, or the results are more meaningful. In other cases, the scores may be binary—i.e., a passed test receives a score of “1” and a failed test receives a score of “0.” In some embodiments the tabulation and aggregation can be automated on the server 104.

In some embodiments, developers that submit designs and/or developed code are rated based on the scores of their submissions. The ratings are calculated based on the ratings of each developer prior to the submission, the assigned difficulty level of the design or program being submitted, and the number of other developers making submissions. It should be understood that a submission could be one design, program, or other computer software asset, or in some cases a number of different assets. A skill rating is calculated for each developer based on each developer's rating prior to the submission and a constant standard rating (e.g., 1200), and a deviation is calculated for each developer based on their volatility and the standard rating.

The expected performance of each developer submitting a design or program is calculated by estimating the expected score of that developer's submission against the submissions of the other developers' submissions, and ranking the expected performances of each developer. The submission can be scored by an reviewer using any number of methods, including, without limitation, those described above.

Based on the score of the submitted software and the scores of submissions from other developers (e.g., whether for the same program or one or more other programs having a similar level of difficulty), each developer is ranked, and an actual performance is calculated based on their rank for the current submission and the rankings of the other developers. In some cases, the submissions from other developers used for comparison are for the same program. In some cases, the submissions from other developers are submissions that are of similar difficulty or scope.

A competition factor also can be calculated from the number of developers, each developer's rating prior to the submission of the design or program, the average rating of the developers prior the submissions, and the volatility of each developer's rating prior to submission.

Each developer can then have their performance rated, using their old rating, the competition factor, and the difference between their actual score and an expected score. This performance rating can be weighted based on the number of previous submissions received from the developer, and can be used to calculate a developer's new rating and volatility. In some cases, the impact that a developer's performance on one submission may be capped such that any one submission does not have an overly significant effect on a developer's rating. In some cases, a developer's score may be capped at a maximum, so that there is a maximum possible rating. The expected project performance of each developer is calculated by estimating the expected performance of that developer against other developers and ranking the expected performances of each participant. The submissions and participants can be scored by the facilitator 400, the entity 208, a review board member, or automatically using the software residing, for example, on the server 104 using any number of methods.

One such example of scoring methodology is described in U.S. Pat. No. 6,569,012, entitled “Systems and Methods for Coding Competitions” by Lydon et al, at, for example, column 15 line 39 through column 16 line 52, and column 18 line 65 through column 21 line 51, and incorporated by reference in their entirety herein. The methodology is described there with reference to programming competitions, and so is applicable to rating the development of software or hardware designs, data models, applications, components, and other work products created as a result of using the methodology described above.

In one embodiment, the external entity 208 is interested in receiving the developed design or the code, as well as obtaining developers' ratings, and in some cases only the ratings. For example, the external entity 208 may ask developers to participate in the development process just so that the developers are rated, and their skills can be objectively evaluated for future projects of greater value, or to determine which developers are more skilled. The requestor could, in addition, have some interest in the developed design or code, and may have some interest in using the developed intellectual asset for its business or otherwise.

There can be a significant benefit to using personnel who are rated highly, using the process described above, as design reviewer(s) in the design review process and/or code reviewer(s) in the code review process. One of the traditional problems with conducting code reviews has been that the abilities of the reviewers were not established. Review by a poorly skilled developer can result in an inadequate review. By using the process to select as reviewers only developers with sufficient skill (as determined by the process), the process itself insures its success.

In one embodiment, this software development process is adopted by a software development group within an organization. The development performed by the group is conducted using this process. Each developer in the group has a rating, and the developers work to improve and/or maintain their ratings. Developers who have high ratings can participate in reviews (e.g., the design review process or the code review process). In one implementation, developers receive additional benefits and or compensation for achieving a high rating. Likewise, developers can receive additional benefits and/or compensation for such participation in a review process. The requestors in this example are product or program managers, charged with directing the software development.

In another implementation, an outside organization such as a consultant can use the system and methods described above to evaluate and rate the development competencies of a development group. In this way, the consultant can rate the developers not only against themselves, but against other developers affiliated with other organizations who have participated or are participating in the system. The evaluator provides the service of evaluation and reporting as described above. One benefit to this approach is that the scoring of the intellectual assets are more likely to be unbiased if the reviewers are not personally known to the developers, and comparing the skills of any one developer against a large pool of developers provides a more accurate representation of that developers skill level with respect to his or her peers.

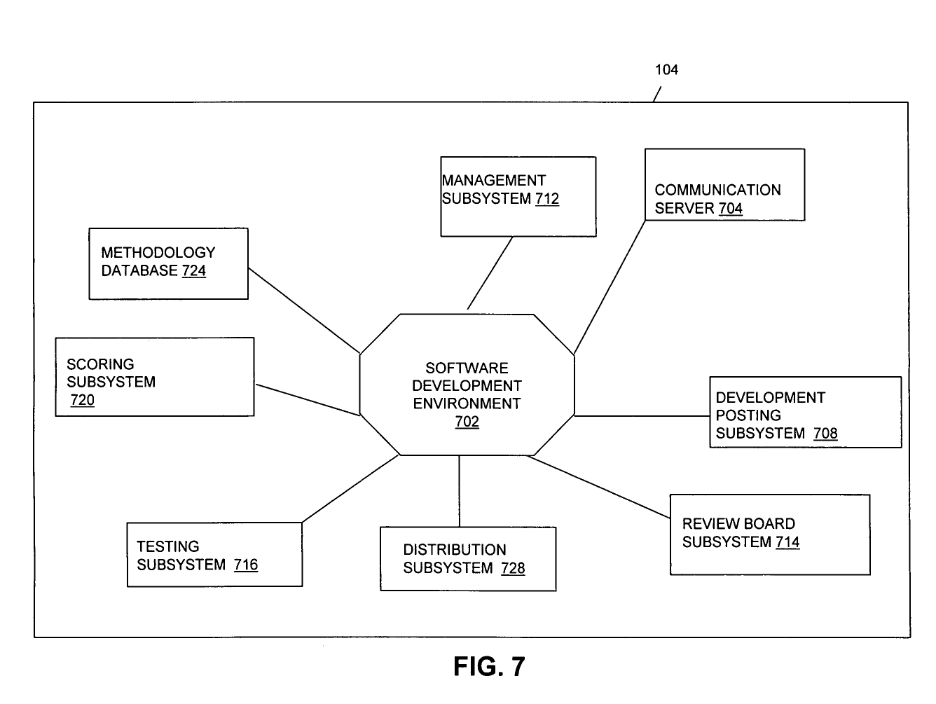

Referring to FIG. 7, the server 104 can include a number of modules and subsystems to facilitate the communication and development of software specifications, designs and programs. The server 104 includes a communication server 704. One example of a communication server 704 is a web server that facilitates HTTP/HTTPS and other similar network communications over the network 112, as described above. The communication server 704 includes tools that facilitate communication among the distributed community of programmers 212, the external entity 208, the facilitator 400, and the members of the review board(s) (commonly referred to as “users”). Examples of the communication tools include, but are not limited to, a module enabling the real-time communication among the developers 404 (e.g., chat), news groups, on-line meetings, and document collaboration tools. The facilitator 400 and/or the external entity 208 can also use the communication server 704 to post design or specifications for distribution to the distributed community of programmers 212.

Furthermore, the server 104 also includes a software development environment 702 to facilitate the software development domain 204 and the design and development process, for example, and the subsystems and modules that support the domain 204. For example, the server 104 can include a development posting subsystem 708, a management subsystem 712, a review board subsystem 714, a testing subsystem 716, a scoring subsystem 720, a methodology database 724, and a distribution subsystem 728.

In one embodiment, the development posting subsystem 708 allows users of the system to post specifications, submit designs, post selected designs, submit software programs and test cases, and post selected software programs for distribution. The posting subsystem 708 identifies the users based on their role or roles, and determines which functions can be accessed based on individual security and access rights, the development phase that a project is currently in, etc. For example, if a particular project is in the design development phase, the posting subsystem 708 can determine that the external entity sponsoring the project has read/write access to the specification, and can re-post an updated specification if necessary. The facilitator 400 may have read access to the specification, as well as access to other specifications attributed to other external entities they may support. In some embodiments, the entire distributed community of programmers may be able to view all of the currently pending specifications, however the posting subsystem may limit full read access to only those developers meeting one or more skill or rating criteria, as described above. Once designs are submitted, access to the submitted designs can be further limited to only review board members, or in some cases other participants in the process.

The development posting subsystem 708 also enables the server 104 or other participants to communicate with potential developers to promote development projects and grow the community of programmers that participate in the development process. In one embodiment, the development posting subsystem 708 displays an advertisement to potential developers. In one embodiment, the advertisement describes the project using text, graphics, video, and/or sounds. Examples of communication techniques include, without limitation, posting these ads on the server's web site, displaying statistics about the project (e.g., planned royalties paid to developers, developers who are participating in this project, development hours available per week). Moreover, in one embodiment the development posting subsystem 708 accepts inquiries associated with development projects. In further embodiments, the development posting subsystem 708 suggests development opportunities to particular developers. The development posting subsystem 708 may analyze, for example, the rating of each member of the distributed community, previous contributions to previous development projects, the quality of contributions to previous component development projects (e.g., based on a score given to each developer's submission(s) as discussed above), and current availability of the developer to participate.

The server 104 also includes a management subsystem 712. The management subsystem 712 is a module that tracks the progress of design and development projects using the software development environment 204. The management subsystem 712 also facilitates the enrollment of new users of the system, and assigns the appropriate security and access rights to the users depending on the roles they have on the various projects. In some versions, the management subsystem 712 can also compile and track operational statistics of the software development environment 204 and users of the system. For example, to determine the appropriate compensation to be awarded to a developer submitting a wining design, the management subsystem 712 may review previously completed projects and assign a similar cash award. Similarly, in cases where the difficulty level of a posted design or program is very high, the management subsystem 712 can review information about individual programmers to determine those developers who have historically performed well on like projects. In addition, the management subsystem 712 may be used to analyze overall throughput times necessary to develop operational programs from a specification provided by an external entity. This can assist users of the system in setting the appropriate deliverable dates and costs associated with new projects.

The server 104 also includes a review board subsystem 714. The review board subsystem 714 allows review board members, external entities, the facilitator, and in some cases developers in the distributed community to review submissions from other developers, as described above. In one embodiment, the communication server 704, the development posting subsystem 708, the management subsystem 712, the review board subsystem 714, the testing subsystem, the scoring subsystem, and the methodology database reside on the server 104. Alternatively, these components of the software development environment 204 can reside on other servers or remote devices.

The server 104 additionally includes a testing subsystem 716. The testing subsystem 716 enables the testing of the submitted programs, applications and/or components. In one embodiment, the testing server 708 is used by the review boards, the facilitator 400, and/or the external entity 208 to review, evaluate, screen and test submitted designs and software programs. The testing subsystem 716 can also execute test cases developed and submitted by the developer 404 against some or all of the submitted programs, as described above. Moreover, the testing subsystem 716 may execute an automated test on the component or application, such as to verify and/or measure memory usage, thread usage, machine statistics such as I/O usage and processor load. Additionally, the testing subsystem 716 can score the component by performance, design, and/or functionality. The testing subsystem 716 can be a test harness for testing multiple programs simultaneously.

The server 104 also includes a scoring subsystem 720. In one embodiment, the scoring subsystem 720 calculates scores for the submissions based on the results from the testing subsystem 716, and in some embodiments ratings for each participant in one or more coding competitions, previous development submissions, or both. In other embodiments, the scoring subsystem 720 can calculate ratings for developers based on their contributions to the project.

The server 104 also includes a methodology database 724. The methodology database 724 stores data relating to the structured development methodology 220. In one embodiment, the methodology 220 may stipulate specific inputs and outputs that are necessary to transition from one phase of the development project to the next. For example, the methodology 200 may dictate that, in order to complete the specification phase of the project and being the design phase, a checklist of items must be completed. Furthermore, the methodology database 724 may store sample documents, designs, and code examples that can be used as templates for future projects, and thus impose a standardized, repeatable and predictable process framework on new projects. This standardization reduces the risks associated with embarking on new software development projects, shortens the overall duration of new development projects, and increases the quality and reliability of the end products.

The server 104 also includes distribution subsystem 728. The distribution subsystem 728 can track and store data relating to software products (e.g., specifications, designs, developed programs) that have been produced using the domain 204. In one embodiment, the distribution subsystem 728 includes descriptive information about the entity 208 that requested the product, the entry and exit points of the domain 204, significant dates such as the request date, and the delivery date, the names and/or nicknames of the developers that participated in the development of the product. The distribution subsystem 728 can also include detailed functional information about the product such as technology used to develop the product, supported computing environments, as well as others. In some embodiments, previously distributed software products may be updated or patched, as described above. In such cases, the distribution subsystem 728 facilitates the identification of the entity or entities 208 that may have older versions of the product, and subsequent communication and distribution of updated versions, where applicable. In some cases, the distribution subsystem 728 can also function as a source code management system, thereby allowing various versions of previously developed software products to branch into distinct software products having a common provenance.

Although described above as independent subsystems and modules, this is for exemplary purposes only and these subsystems and modules may alternatively be combined into one or more modules or subsystems. Moreover, one or more of the subsystems described above may be remotely located from other modules (e.g., executing on another server 104 in a server farm).

Although described here with reference to software, and useful when implemented with regard to software components, the cooperatively developed product can be any sort of tangible or intangible object that embodies intellectual property. As non-limiting examples, the techniques could be used for computer hardware and electronics designs, or other designs such as architecture, construction, or landscape design. Other non-limiting examples for which the techniques could be used include the development of all kinds of written documents and content such as documentation and articles for papers or periodicals (whether on-line or on paper), research papers, scripts, multimedia content, legal documents, and more.

What is claimed is:

1. A computerized method for developing a software application, the method comprising:
facilitating a plurality of online software programming contests, a subset of the contests resulting in one or more software components;
communicating a specification for the design of a software application to a plurality of developers, the specification describing a plurality of the software components to be used in the development of the application;
receiving, from each of a subset of the plurality of software developers, in response to the communicated specification, an assembled application comprised of one or more of the software components;
facilitating a review process for scoring each of the received applications; and
selecting one application from the received applications based at least in part on its score in the review process.

2. The method of claim 1 wherein each of the plurality of software developers were rated in one or more coding competitions.

3. The method of claim 2 wherein the plurality of developers is selected, at least in part, based on having a minimum rating received in the one or more coding competitions.

4. The method of claim 1 further comprising associating a difficulty level with the software application.

5. The method of claim 4 wherein the developers are rated at least in part based on the difficulty level associated with the application.

6. The method of claim 1 wherein the plurality of software developers are geographically distributed.

7. The method of claim 1 wherein the assembled application comprises one or more of a requirements document, an activity diagram, a case document, test cases, a prototype, and a UML document.

8. The method of claim 1 wherein the specification is communicated using an on-line application.

9. The method of claim 1 further including rewarding the software developer that submitted the selected application.

10. The method of claim 9 wherein the reward is monetary.

11. The method of claim 9 wherein the reward is an increased skill rating.

12. The method of claim 1 further comprising, prior to communicating the specification, receiving at least a portion of the specification from an entity requesting the development of an application.

13. The method of claim 1 wherein the review process is performed by a plurality of reviewers.

14. The method of claim 13 wherein each of the plurality of reviewers were rated in a computer programming competition.

15. The method of claim 14 wherein the ratings of each of the plurality of reviewers are above a predetermined minimum rating.

16. The method of claim 13 wherein the review process comprises aggregating scores from each of the plurality of reviewers into a summary score and the selection of one application is based on the summary score.

17. The method of claim 1 wherein the review comprises one or more of reading documents, completing a review form, and identifying changes to be incorporated into the application by the software developer who submitted the application.

18. The method of claim 17 wherein the identified changes are designated mandatory or optional at the reviewers discretion.

31. The method of claim 1 wherein the received application comprises one or more of source code, object code, and compiled code.

20. A computerized system for developing software applications, the system comprising:
a contest server for facilitating a plurality of online software programming contests, a subset of the contests resulting in one or more software components;
a communications server for communicating a specification for the design of a software application to a plurality of developers, the specification describing a plurality of the software components to be used in the development of the application; and
a scoring server in communication with the communications server for scoring the received candidate applications based at least in part on a review of the submitted applications.
